(19) United States
(12) Patent Application Publication
(10) Pub. No.: US 2008/0018487 A1
(43) Pub. Date: Jan. 24, 2008

(54) Monitoring apparatus capable of communicating with mobile communication apparatus

(75) Inventors: Chia Wei Jao, Taipei (TW); Hsi-Yung Liu, Taipei (TW); Chuan Yuan Lee, Taipei (TW)

Correspondence Address: REED SMITH LLP, Suite 1400, 3110 Fairview Park Drive, Falls Church, VA, 22042, US

(73) Assignee: Compal Communications, Inc.

(21) Appl. No.: 11/878,105

(22) Filed: Jul. 20, 2007

(30) Foreign Application Priority Data
Jul. 21, 2006 (TW) 095212900

(51) Int. Cl. G08B 23/00

(52) U.S. Cl. 340/693.12

(57) ABSTRACT

The invention is to provide a monitoring apparatus capable of communicating with a mobile communication apparatus. The monitoring apparatus according to a preferred embodiment of the invention includes a base, a rotating device, a casing, an image capturing module, a transmitting/receiving unit, and a processing/controlling module. The image capturing module is used for capturing an image and transmitting the captured image. The processing/controlling module is used for receiving a control signal transmitted from the mobile communication apparatus through the transmitting/receiving unit, controlling, according to the control signal, the rotating device to actuate the image capturing module together with the casing and the rotation shaft to rotate to a desired angle, receiving the captured image, and transmitting the captured image to the mobile communication apparatus through the transmitting/receiving unit.

### BACKGROUND OF THE INVENTION

1. Field of the Invention

The invention relates to a monitoring apparatus, and more particularly, to a monitoring apparatus capable of communicating with a mobile communication apparatus.

2. Description of the Prior Art

Recently, with the increased requirement of home security, more and more monitoring apparatuses have been installed in houses.

However, conventional monitoring apparatuses on business situation are only capable of monitoring a limited angle range at a fixed direction. Therefore, a dead space exists around the house. Besides, the monitoring apparatuses are only capable of transmitting image signals in one-way, and then a captured image is watched on a display, so that the monitoring apparatuses can not be used flexibly.

Hence, a scope of the invention is to provide a monitoring apparatus capable of communicating with a mobile communication apparatus. A user can control the monitoring apparatus to rotate in the range of 360 degrees through the mobile communication apparatus. Moreover, the image captured by the monitoring apparatus is capable of being transmitted to the mobile communication apparatus. When the monitoring apparatus detects someone invading or a fire accident happening, it can notify the predetermined related staffs or units immediately to handle the situations.

### SUMMARY OF THE INVENTION

A scope of the invention is to provide a monitoring apparatus capable of communicating with a mobile communication apparatus. A user can control the monitoring apparatus of the invention by utilizing the mobile communication apparatus to rotate in a range of 360 degrees for decreasing a dead space of vision. Furthermore, the monitoring apparatus of the invention is capable of transmitting the captured image to the mobile communication apparatus.

According to a preferred embodiment, the monitoring apparatus of the invention comprises a base, a rotating device, a casing, an image capturing module, a transmitting/receiving unit, and a processing/controlling module. The base is capable of being mounted on an object. The rotating device is disposed on the base and comprises a rotation shaft. The casing is mounted on the rotation shaft. The image capturing module is disposed on an inner surface of the casing, for capturing an image and transmitting the captured image. The transmitting/receiving unit is disposed in the casing. The processing/controlling module is disposed in the casing, and electrically connected to the image capturing module, the rotating device, and the transmitting/receiving unit respectively. The processing/controlling module is applied for receiving a control signal transmitted from the mobile communication apparatus through the transmitting/receiving unit. The processing/controlling module controls, according to the control signal, the rotating device to actuate the image capturing module together with the casing and the rotation shaft to rotate to a desired angle within an angle range. The processing/controlling module receives the captured image and transmits the captured image to the mobile communication apparatus through the transmitting/receiving unit.

The advantage and spirit of the invention may be understood by the following recitations together with the appended drawings.

### BRIEF DESCRIPTION OF THE APPENDED DRAWINGS

FIG. 1 is a schematic diagram of a monitoring apparatus according to the first preferred embodiment of the invention.

FIG. 2 is a schematic diagram of a base of the monitoring apparatus and a rotating device disposed on the base according to the first preferred embodiment of the invention.

FIG. 3 is a functional block diagram of the communication between the monitoring apparatus of the first preferred embodiment of the invention and a mobile communication apparatus.

FIG. 4 is a schematic diagram of a monitoring apparatus according to the second preferred embodiment of the invention.

FIG. 5 is a functional block diagram of the communication between the monitoring apparatus of the second preferred embodiment of the invention and a mobile communication apparatus.

### DETAILED DESCRIPTION OF THE INVENTION

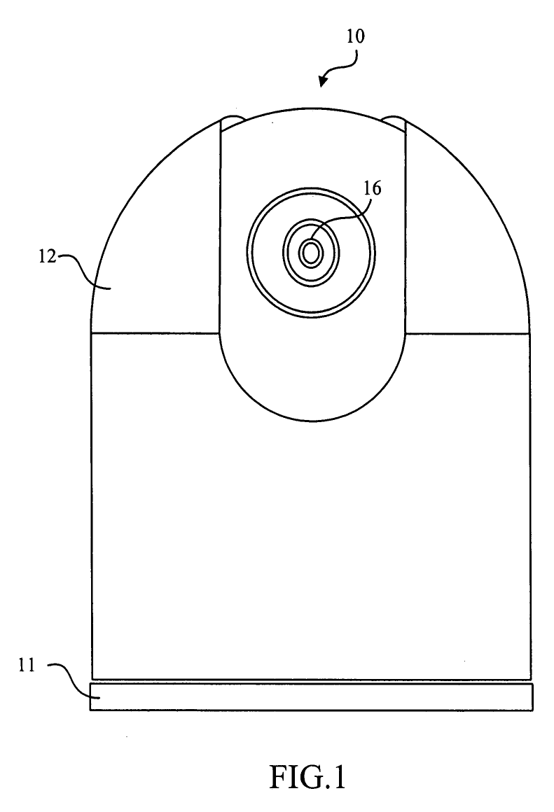

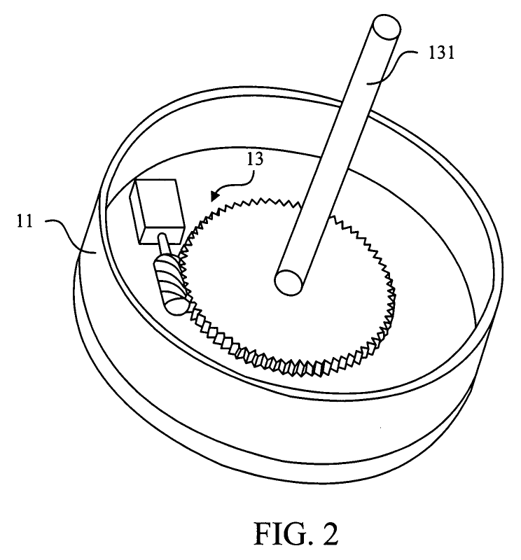

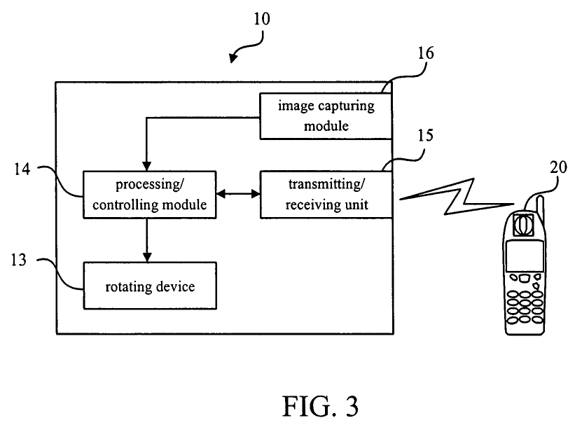

Please refer to FIG. 1 through FIG. 3. FIG. 1 is a schematic diagram of a monitoring apparatus according to the first preferred embodiment of the invention. FIG. 2 is a schematic diagram of a base of the monitoring apparatus and a rotating device disposed on the base according to the first preferred embodiment of the invention. FIG. 3 is a functional block diagram of the communication between the monitoring apparatus of the first preferred embodiment of the invention and a mobile communication apparatus.

As shown in FIG. 1 through FIG. 3, the monitoring apparatus 10 of the first preferred embodiment of the invention is capable of communicating with the mobile communication apparatus 20. The monitoring apparatus 10 comprises a base 11, a rotating device 13, a casing 12, an image capturing module 16, a transmitting/receiving unit 15, and a processing/controlling module 14.

The base 11 is capable of being mounted on an object. The rotating device 13 is disposed on the base 11 and comprises a rotation shaft 131. The casing 12 is mounted on the rotation shaft 131.

The image capturing module 16 is disposed on an inner surface of the casing 12. The image capturing module 16 is applied for capturing an image and transmitting the captured image.

The transmitting/receiving unit 15 is disposed in the casing 12.

The processing/controlling module 14 is disposed in the casing 12 and electrically connected to the image capturing module 16, the rotating device 13, and the transmitting/receiving unit 15 respectively. The processing/controlling module 14 is used for receiving a control signal transmitted from the mobile communication apparatus 20 through the transmitting/receiving unit 15. The processing/controlling module 14 controls, according to the control signal, the rotating device 13 to actuate the image capturing module 16 together with the casing 12 and the rotation shaft 131 to rotate to a desired angle within an angle range. The processing/controlling module 14 receives the captured image and transmits the captured image to the mobile communication apparatus 20 through the transmitting/receiving unit 15.

In an embodiment, the angle range is between 0 and 360 degrees.

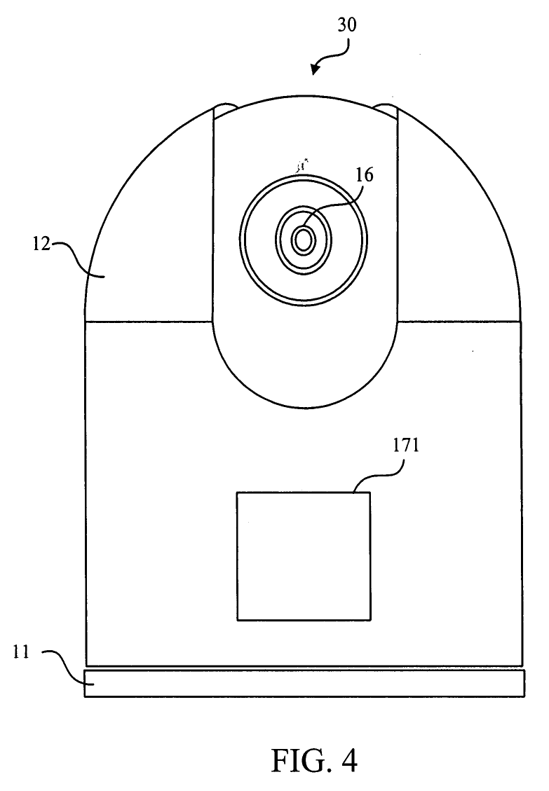

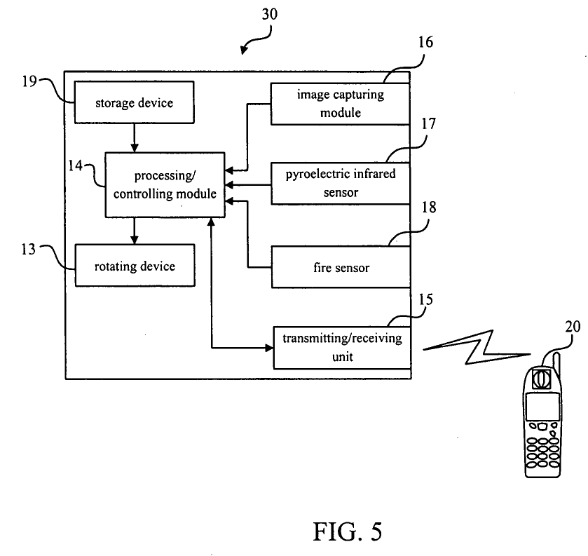

Please refer to FIG. 4 and FIG. 5. FIG. 4 is a schematic diagram of a monitoring apparatus according to the second embodiment of the invention. FIG. 5 is a functional block diagram of the communication between the monitoring apparatus of the second preferred embodiment of the invention and a mobile communication apparatus.

As shown in FIG. 4 and FIG. 5, the monitoring apparatus 30 of the second embodiment of the invention is capable of communicating with the mobile communication apparatus 20.

The units with the same symbols in FIG. 4 and FIG. 1 are the units mentioned in previous paragraphs and will not be described in the following paragraphs. The units with the same symbols in FIG. 5 and FIG. 3 are the units mentioned in previous paragraphs and will not be described in the following paragraphs.

The difference between the monitoring apparatus 30 according to the second preferred embodiment of the invention and the monitoring apparatus 10 according to the first preferred embodiment of the invention is described as below.

The monitoring device 30 further comprises a pyroelectric infrared sensor (PIR) 17, a fire sensor 18, and a storage device 19.

The pyroelectric infrared sensor 17 has a pyroelectric element 171. The pyroelectric infrared sensor 17 is mounted on a surface of the casing 12 and electrically connected to the processing/controlling module 14. The pyroelectric infrared sensor 17 is used for detecting its adjacent area. When the pyroelectric element 171 detects a change of infrared radiation in its adjacent area, the pyroelectric infrared sensor 17 generates a first trigger signal and transmits the first trigger signal.

The fire sensor 18 (not shown in FIG. 4) is disposed on the casing 12 and electrically connected to the processing/controlling module 14. The fire sensor 18 is used for generating a sensing signal associated with its adjacent area, judging if the sensing signal meets a criterion, and if yes, generating a second trigger signal and transmitting the second trigger signal.

The storage device 19 is disposed in the casing 12 and electrically connected to the processing/controlling module 14. The storage device 19 is used for storing a contact rule associated with the first trigger signal and a contact rule associated with the second trigger signal. The contact rule associated with the first trigger signal corresponds to N mobile communication apparatus. The contact rule associated with the second trigger signal corresponds to M mobile communication apparatus. N and M are natural numbers.

The processing/controlling module 14 receives the first trigger signal from the pyroelectric infrared sensor 17 and transmits a first information to the N mobile communication apparatus through the transmitting/receiving unit 15.

The processing/controlling module 14 receives the second trigger signal from the fire sensor 18 and transmits a second information to the M mobile communication apparatus through the transmitting/receiving unit 15.

In practice, when a user utilizes the monitoring apparatus of the above-mentioned preferred embodiment of the invention, the user can use a mobile communication apparatus, such as a mobile phone, to operate the monitoring apparatus. When the user operates the monitoring apparatus, the mobile communication apparatus transmits a control signal. The control signal is transmitted to the processing/controlling module through the transmitting/receiving unit. The processing/controlling module controls, according to the control signal, the rotating device to actuate the image capturing module together with the casing and the rotation shaft to rotate to a desired angle. The monitoring apparatus is capable of rotating within an angle range of 360 degrees.

The image capturing module of the monitoring apparatus is used for capturing an image and transmitting the captured image to the processing/controlling module. The processing/controlling module transmits the captured image to the mobile communication apparatus through the transmitting/receiving unit. The user can watch the image captured by the image capturing module on the mobile communication apparatus.

Furthermore, the monitoring apparatus has a pyroelectric infrared sensor. The pyroelectric infrared sensor is capable of detecting its adjacent area for invasion of stranger. The pyroelectric infrared sensor generates a trigger signal and transmits the trigger signal to the processing/controlling module when the pyroelectric element detects a change of infrared radiation in its adjacent area. The processing/controlling module transmits an information to at least one mobile communication apparatus according to the contact rule associated with the trigger signal in the storage device. For example, the monitoring apparatus is capable of calling the police office and using speech sounds stored in advance to report a case. The monitoring apparatus is also capable of sending a short message to the user and the family of the user to notify them the invasion situation of their house.

Furthermore, the monitoring apparatus has a fire sensor. The fire sensor is capable of generating a sensing signal associated with its adjacent area, and judging if the sensing signal meets a criterion, and if yes, the fire sensor generating a trigger signal and transmitting the trigger signal to the processing/controlling module. The processing/controlling module transmits an information to at least one mobile communication apparatus according to contact rules associated with the trigger signal in the storage device. For example, the monitoring apparatus is capable of calling the fire bureau and using speech sounds stored in advance to report a case. The monitoring apparatus is also capable of sending a short message to the user and the family of the user to notify them that a fire accident happens in their house.

Obviously, according to the monitoring apparatuses of the first and the second preferred embodiments of the invention, the user can use a mobile communication apparatus to communicate with the monitoring apparatus. Therefore, the user can use the mobile communication apparatus to operate the monitoring apparatus. The monitoring apparatus is capable of rotating within an angle range of 360 degrees. Furthermore, the image captured by the monitoring apparatus can be transmitted to the mobile communication apparatus. Besides, the monitoring apparatus also comprises a pyroelectric infrared sensor and a fire sensor. When a stranger intrudes or a fire accident happens, the monitoring apparatus can notify the related units or persons according to the pre-stored contact rules. Therefore, the monitoring apparatus of the invention has practicability and convenience in operation.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A monitoring apparatus capable of communicating with a mobile communication apparatus, the monitoring apparatus comprising:
a base capable of being mounted on an object;
a rotating device, disposed on the base and comprising a rotation shaft;
a casing, mounted on the rotation shaft;
an image capturing module, disposed on an inner surface of the casing, for capturing an image and transmitting the captured image;
a transmitting/receiving unit, disposed in the casing; and
a processing/controlling module, disposed in the casing and electrically connected to the image capturing module, the rotating device, and the transmitting/receiving unit respectively, for receiving a control signal transmitted from the mobile communication apparatus through the transmitting/receiving unit, controlling, according to the control signal, the rotating device to actuate the image capturing module together with the casing and the rotation shaft to rotate to a desired angle in an angle range, receiving the captured image, and transmitting the captured image to the mobile communication apparatus through the transmitting/receiving unit.

2. The monitoring apparatus of claim 1, wherein the angle range is between 0 and 360 degrees.

3. The monitoring apparatus of claim 1, further comprising:
a pyroelectric infrared sensor (PIR), having a pyroelectric element, mounted on a surface of the casing and electrically connected to the processing/controlling module, for detecting the neighboring thereof, generating a first trigger signal when the pyroelectric element detects a change of infrared radiation in the neighboring thereof, and transmitting the first trigger signal; and
a storage device, disposed in the casing and electrically connected to the processing/controlling module, for storing a contact rules associated with the first trigger signal, the contact rule corresponding to N mobile communication apparatus, N being a natural number, wherein the processing/controlling module receives the first trigger signal from the pyroelectric infrared sensor and transmits a first information to the N mobile communication apparatus through the transmitting/receiving unit.

4. The monitoring apparatus of claim 1, further comprising:
a fire sensor, disposed on the casing and electrically connected to the processing/controlling module, for generating a sensing signal associated with the neighboring thereof, judging if the sensing signal meets a criterion, and if yes, generating a second trigger signal and transmitting the second trigger signal; and
a storage device, disposed in the casing and electrically connected to the processing/controlling module, for storing a contact rule associated with the second trigger signal, the contact rule corresponding to M mobile communication apparatus, M being a natural number, wherein the processing/controlling module receives the second trigger signal from the fire sensor and transmits a second information to the M mobile communication apparatus through the transmitting/receiving unit.
